(19) United States
(12) Patent Application Publication
(10) Pub. No.: US 2007/0283535 A1
(43) Pub. Date: Dec. 13, 2007

(54) VEHICLE GULL-WING DOOR HINGE

(75) Inventor: Lawrence Andrew Hoffman, Portland, OR (US)

Correspondence Address: PAUL J. FORDENBACHER;SILICON FOREST PATENT GROUP, 11876 NW TYLER CT., PORTLAND, OR, 97229, US

(73) Assignee: THE HOFFMAN GROUP, LLC, Portland, OR (US)

(21) Appl. No.: 11/757,337

(22) Filed: Jun. 1, 2007

Related U.S. Application Data
(60) Provisional application No. 60/803,666, filed on Jun. 1, 2006.

(51) Int. Cl. E05D 3/06

(52) U.S. Cl. 16/366

(57) ABSTRACT

A hinge for automobile doors so as to provide for gull-wing operation comprising fastening elements provided with fixed pivot pins and with sliding guides, which can be housed respectively in the thickness of the door and in a corresponding roof header; linkages for connecting the fastening elements with their first extremity, hinged on the fixed pivot pin of one of the fastening elements and with a second extremity including a shoe engaged in the sliding guide of the other fastening element; and a joint interposed at the extremities of the linkages which pivotally connects the linkages to each other allowing their relative angular mobility. The fastening elements further comprise a control means in cooperative engagement with the sliding guide and shoe for adjustably controlling the maximum range of rotation of the hinge.

### FIELD OF THE INVENTION

This invention relates to vehicle doors, and more particularly, to a single-axis door hinge and methods for gull-wing operation.

### BACKGROUND OF INVENTION

It is well known in motor vehicles to have a front door opening and a rear door opening which are respectively closed by separate front and rear doors. Conventional car doors are typically hinged at the front-facing edge of the door and allow the door to swing outward from the body of the car.

The term gull-wing door is used to describe automobile doors which are hinged at the roof. They are so named because, when opened, the doors evoke the image of a seagull's wings. The most well-known examples of road-cars with gull-wing doors are the Mercedes-Benz 300SL from the 1950s, the Bricklin SV-1 from the 1970s and the De Lorean DMC-12 from the 1980s.

Despite the common misconception that the gull-wing doors are mere stylistic affectations, the design is a very practical one. The advantage is that when properly designed and counterbalanced (e.g. the De Lorean), they require little side-clearance to open (about 27.5 cm, or 1 inches in the De Lorean) and allow much better entrance/egress than conventional doors. This is especially important for vehicles like the De Lorean whose width would make conventional doors awkward to use when the car is in a conventional urban parking space.

Gull-wing doors have a somewhat questionable reputation because of early examples like the Mercedes and the Bricklin. The Mercedes 300 SL used the door design to allow an unusual chassis design which required a very high door sill and forced the doors to be smaller than would otherwise have been optimal. The Bricklin was a more conventional sized door but the actuation system was problematic in day-to-day use and led to unreliable operation. In addition, there was some concern that in making the door as light as possible, it couldn't provide adequate protection in side-impact accidents.

The De Lorean addressed these problems by using a solid-steel torsion bar to counterbalance a full-sized door and then used simple pneumatic struts similar to those found in hatchback cars to open the doors and dampen the movement of the doors.

For the most part, gull-wing door operation has been available only on expensive luxury performance automobiles and automobiles assembled from a kit by the consumer. These vehicles have door and door jam configurations, overly-complex hinge mechanisms, and latching mechanisms specifically designed into the automobile to permit the door to open vertically.

It would, therefore, be highly desirable to have components and assemblies that provide automobile manufacturers and aftermarket enthusiasts the ability to incorporate gull-wing door operation in currently designed automobiles without major modification to the automobile body or door structures.

The present invention provides a new and improved gull-wing door hinge and the mechanisms to retrofit conventional doors for gull-wing door operation.

### BRIEF DESCRIPTION OF DRAWINGS

FIG. 1 is a perspective view of a two-door automobile having doors operable in the gull-wing configuration, in accordance with an embodiment of the present invention;

FIG. 2 is a perspective view of a four-door automobile also having doors operable in the gull-wing configuration, in accordance with another embodiment of the present invention;

FIG. 3 is a partial cut-away sectional view along cut-line 3-3 of FIG. 2 wherein the door is shown in the closed position and the open position shown in phantom;

FIG. 4 is a perspective view of an automobile wherein suitable hinge-mounting structures include a roof pillar and a door pillar, providing a modified gull-wing door operation, in accordance with other embodiments of the present invention;

FIGS. 5, 6 and 7 are perspective and cross-sectional views of a hinge in accordance with an embodiment of the present invention;

FIG. 8 is a cross-sectional view of another hinge in accordance with an embodiment of the present invention; and

FIG. 9 is a front view of a hinge as shown in a typical installation, in accordance with the present invention.

### DESCRIPTION

In the following detailed description, reference is made to the accompanying drawings which form a part hereof wherein like numerals designate like parts throughout, and in which is shown by way of illustration specific embodiments in which the invention may be practiced. It is to be understood that other embodiments may be utilized and structural or logical changes may be made without departing from the scope of the present invention. Therefore, the following detailed description is not to be taken in a limiting sense, and the scope of the present invention is defined by the appended claims and their equivalents.

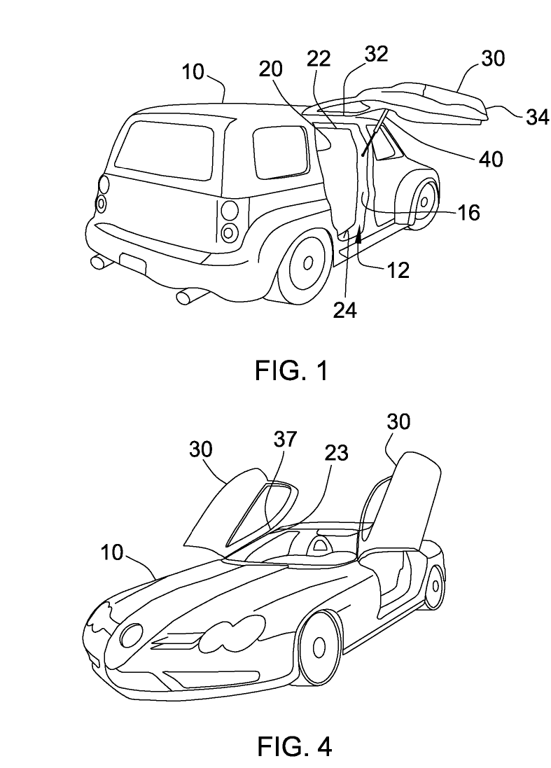

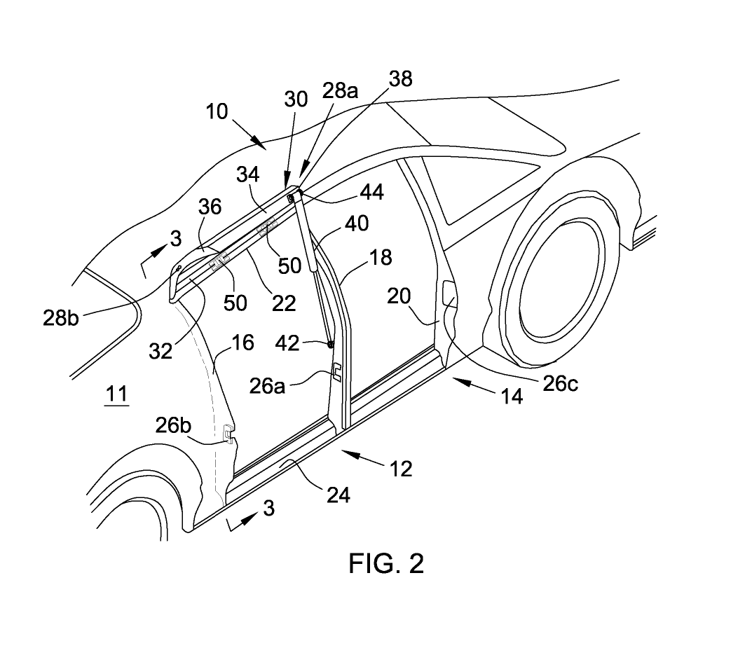

FIG. 1 is a perspective view of a two-door automobile having doors operable in the gull-wing configuration, in accordance with an embodiment of the present invention. FIG. 2 is a perspective view of a four-door automobile also having doors operable in the gull-wing configuration, in accordance with another embodiment of the present invention. The following description will refer to the four-door automobile but it is appreciated that embodiments of the present invention are also suitable for the two-door automobile.

Referring to FIG. 2, a vehicle body 10 includes a front door opening 12 and a rear door opening 14. The front door opening 12 is defined by a front pillar 16 and a middle pillar 18. The rear door opening 14 is defined by the middle pillar 18 and a rear pillar 20. The upper edge of the door openings 14, 16 is defined by a roof header 22 and the bottom edge is defined by a rocker panel 24.

A door 30 for closing the door openings 12, 14 includes a door upper edge 32 and a door lower edge 34. The door upper edge 32 is hinged to the roof header 22 at one or more hinges 50. The hinge 50 suitable for the particular purpose and in accordance with the present invention is described below.

Referring to the door 30 and the front door opening 12, a striker 28a is mounted on the door rear edge 38 and may be the stock striker on the retrofitted automobile or a particular striker suitable for the particular purpose. A door latch 26a is mounted on the middle pillar 18 facing the front opening 12 and may be the stock door latch on the retrofitted automobile or a particular door latch suitable for the particular purpose. The striker 28a receives the door latch 26a when the door 30 is in the closed position to latch and secure the door 30 in the closed position.

Similarly, a door latch 26b may be provided on the front pillar 16 facing the front opening 12 to receive a striker 28b provided on the door front edge 36. The door latch 26b provided on the front pillar 16 may be used singularly, or in combination, with a second door latch 26a provided on the middle pillar 18 as described above.

Similarly, a striker 28 and door latch 26 may be provided for the rear door and door opening as is described above. It is appreciated that the striker 28 and the door latch 26 may be alternatively coupled in switched arrangement to the respective door and door pillar so as to provide substantially the same operational characteristics of latching and securing the door 30 in the closed position.

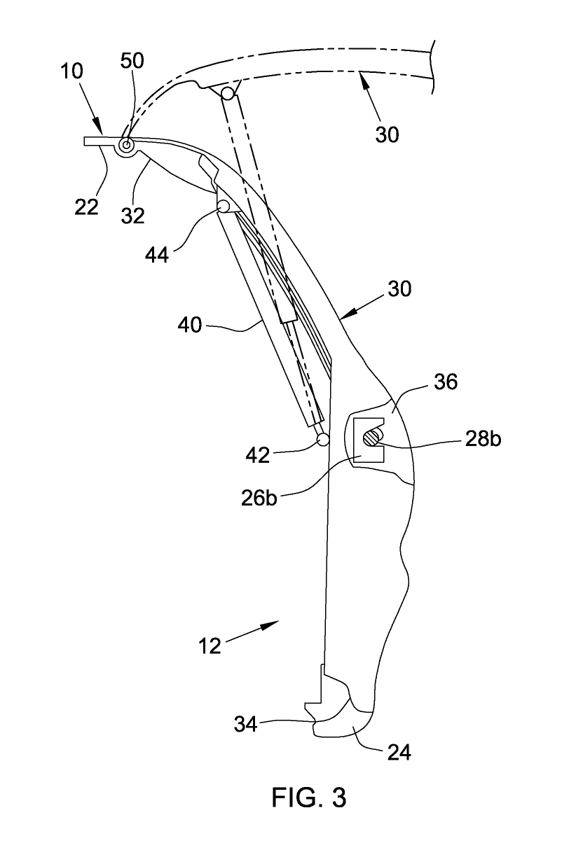

FIG. 3 is a partial cut-away sectional view along cut-line 3-3 of FIG. 2 wherein the door is shown in the closed position and the open position shown in phantom. In the closed position, the striker 28b is captured within the door latch 26b to maintain the door 30 in the closed position.

The door 30 is moved from the closed position to the open position by actuating the door latch 26b to release the striker 28b. The door lower edge 34 is pushed outwardly via a handle (not shown). In an embodiment in accordance with the present invention, the opening movement of the door 30 is assisted by a linear actuator, such as, but not limited to, a telescoping strut 40 which is pivotally coupled to a suitable structure, shown in FIG. 3 coupled to the middle pillar 18, by a pillar pivot 42 and attached to the door 30 by a door pivot 44. The door 30 is adapted to swing upwardly until it reaches the full open position shown in phantom in FIG. 2, in which the door lower edge 34 of the door 30 extends generally upward above the vehicle body 10 to provide full and unobstructed ingress and egress for passengers through the door opening 12, 14.

Other linear actuators are appreciated. In an embodiment, the linear actuator is electrically driven so as to provide a power-driven operation at a touch of a button. Apparatus that provides the function of the linear actuator includes, but is not limited to, a gas strut, a pneumatic piston, a hydraulic piston, an electrically-driven linear actuator, a spring-loaded telescoping hinge, and an electromagnetic linear actuator.

It is understood that embodiments of the present invention provided above are suitable for automobiles having only two doors as shown in FIG. 1.

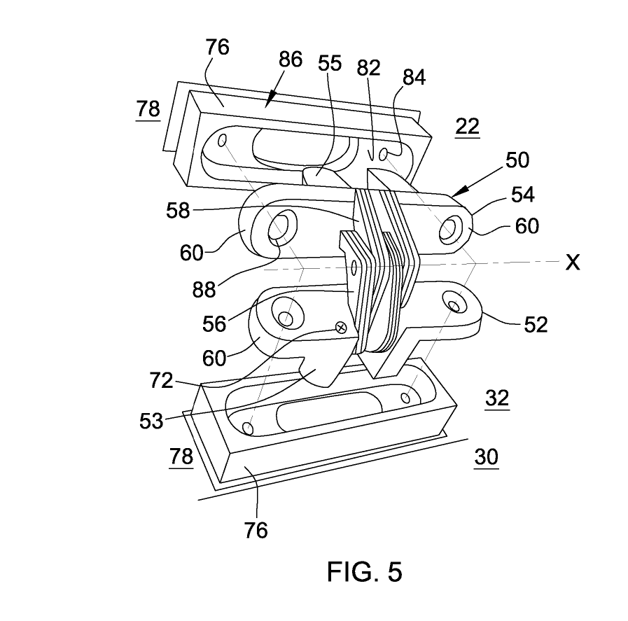

FIG. 4 is a perspective view of an automobile wherein suitable hinge-mounting structures include a roof pillar 23 and a door pillar 37, providing a modified gull-wing door operation, in accordance with other embodiments of the present invention. The embodiment of FIG. 4 is particularly suitable wherein the roof pillar 23 and the door pillar 37 are suitably parallel allowing for one or more hinges 50 may be provided.

Various types of hinges may be used to couple the door to the roof header, but in particular, a hidden hinge as described in accordance with the present invention is particularly suited for the purpose. The hinge of the present invention is partly contained within the thickness of the door and partly within the thickness of the roof header. The hinge comprises two fastening elements adapted to couple the hinge respectively to the door and to the roof header; linkages, each of which is connected to the two fastening elements with their first extremity hinged on a fixed pivot pin of one of the fastening elements and with the other extremity engaged in a sliding guide borne by the other fastening element; and a pivot pin, interposed at the extremities of the linkages, which connects the linkages in mutually pivoting fashion being able to move, remaining parallel to itself, in the opening and closing motion of the door. The hinge further comprises a maximum opening controlling means for controlling the extent of rotation of the hinge.

In practice, the hinge allows for the door to be opened at a maximum angle alpha. of substantially 180 degrees, the maximum extent of rotation controlled by the maximum opening controlling means. Depending on the installation, the hinge is controlled to open less than 180 degrees. In one embodiment, the maximum opening controlling means is a non-adjustable feature of the hinge. In other embodiments, the maximum opening controlling means is user adjustable providing one of a range of opening angles suitable for a particular purpose.

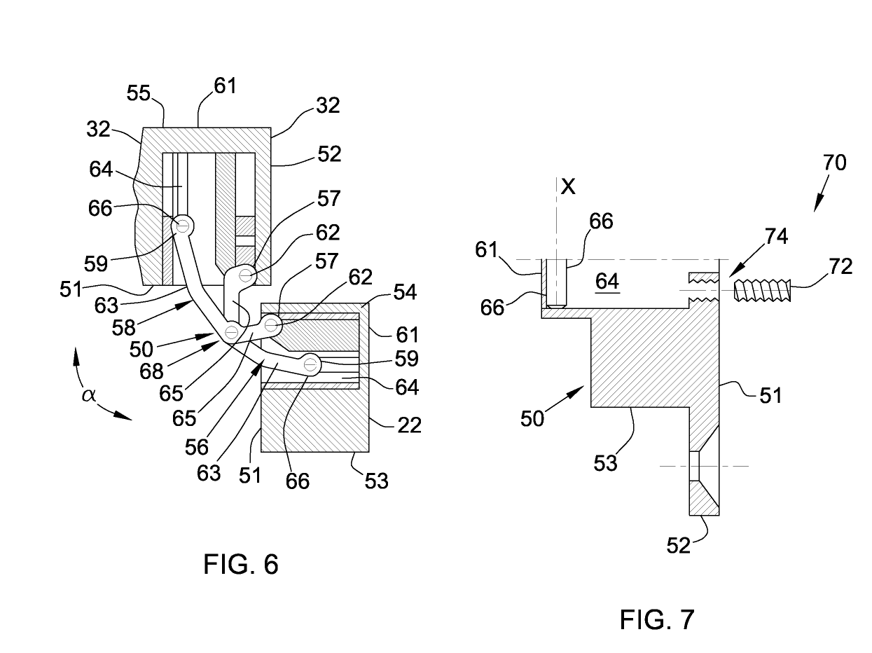

FIGS. 5, 6 and 7 are perspective and cross-sectional views of the hinge 50 in accordance with an embodiment of the present invention. The hinge 50 comprises a first fastening element 52 and a second fastening element 54, adapted to be coupled to the door 30 and to the roof header 22, and first linkage 56 and second linkage 58 which, advantageously articulated to each other and to the fastening elements 52, 54, allow to couple the door 30 pivotally to the roof header 22, as is necessary for the related opening and closing. The fastening elements 52, 54 are embodied by corresponding internally hollow bodies 53, 55, preferably made of metallic material and provided with planar flanges 60. The bodies 53, 55 are housed in the thickness of the door upper edge 32 and of the roof header 22 and in the closed condition of the door 30 they are substantially mutually opposed and aligned at some angle .alpha. of zero or greater.

Each of the bodies 53, 55 is internally provided with a fixed pivot pin 62 and with a sliding guide 64. The pivot pin 62 is oriented parallel to a first direction X shown in FIG. 5 and that is orthogonal to the view shown in FIGS. 6 and 7. The sliding guides 64 are instead rectilinear and oriented orthogonal to the pivot pins 62.

Each linkage 56, 58 is coupled to both fastening elements 52, 54. More in particular, a first extremity 57 of each linkage 56, 58 is hinged on the fixed pivot pin 62 of one of the fastening elements 52, 54, and the second extremity 59, which is provided with a shoe 66, is engaged in the sliding guide 64 of the other fastening element 52, 54.

The two linkages 56, 58 are mutually connected in pivoting fashion by a joint 68 situated between the related extremities 57, 59.

The linkages 56, 58 generally have elongated, globally curvilinear shapes, substantially similar in design and dimensions, devised to allow, when installed on a vehicle as shown in FIGS. 3 and 5, the door 30 to rotate relative to the roof header 22 between two extreme positions: in the first whereof, the door 30 is closed and aligned with its own door exterior face 31 to the outer surface 11 of the automobile shown in FIG. 2; in the second position the door 30 being open and positioned above the automobile body 10.

More specifically, defining as a first linkage portion 63 that part of the linkages 56, 58 that is situated between the first extremity 57 and the joint 68 and as a second linkage portion 65 that part that is situated between the joint 68 and the second extremity 59, wherein the two linkages 56, 58 have mutually the same lengths, both in correspondence with their first linkage portions 63, and in correspondence with their second linkage portions 65.

The hinge 50 is advantageously constructed in such a way as to be also adjustable in range of rotation according to the spatial direction .alpha. and upon the activation of related adjustment means 70.

Referring to FIG. 7, in accordance with an embodiment of the present invention, the adjustment means 70 comprises a set screw 72 adapted for operable engagement with a threaded bore 74 extending from the hinge front 51 and in operable alignment with the sliding guide 64. The set screw 72 extends into the sliding guide 64 so as to engage the shoe 66 slidingly engaged with the sliding guide 64 so as to limit the maximum extent of translation of the shoe 66 within the sliding guide 64 controlling the angle .alpha. in which the hinge 50 opens. Rotation of the set screw 72 in a first direction extends the set screw 72 further into operable engagement with the sliding guide 64, further restricting the range of motion of the shoe 66 and thus the range of rotation of the hinge 50. Rotation of the set screw 72 in a second direction opposite the first direction backs out the set screw 72 from the sliding guide 64, allowing for a greater range of motion of the shoe 66 and thus the range of rotation of the hinge 50. In this arrangement, the extent of the range of opening .alpha. of the hinge 50 is adjustable to an opening angle of substantially 180 degrees or less. This is desirable, such as, but not limited to, such that in the open position, the door does not impact the roof of the automobile, and such that in the open position, the door is easily reached for closing. The set screw 72 is accessible and adjustable from the hinge front 51 and as such is adjustable while the hinge 50 is installed in the automobile. It is appreciated that the adjustment means 70 provided above may be provided in either or both of the bodies 53, 55.

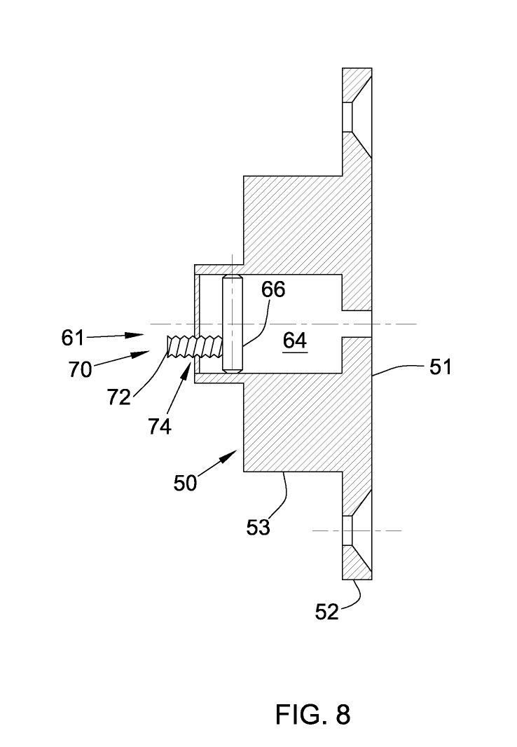

FIG. 8 is a cross-sectional view of hinge 50 in accordance with another embodiment of the present invention, including an adjustment means 70 comprising a set screw 72 adapted for operable engagement with a threaded bore 74 extending from the hinge rear 61 and in operable alignment with the sliding guide 64. The set screw 72 engages the shoe 66 slidingly engaged with the sliding guide 64 so as to limit the extent of translation of the shoe 66 within the sliding guide 64 controlling the angle .alpha. in which the hinge 50 closes. Rotation of the set screw 72 in a first direction extends the set screw 72 further into operable engagement with the sliding guide 64, further restricting the range of motion of the shoe 66 and thus the range of rotation of the hinge 50. Rotation of the set screw 72 in a second direction opposite the first direction backs out the set screw 72 from the sliding guide 64, allowing for a greater range of motion of the shoe 66 and thus the range of rotation of the hinge 50. In this arrangement, the extent of the range of closing of the hinge 50 is limited and adjustable to a closing angle of substantially zero degrees or more. This is desirable, such as, but not limited to, such that in the closed position, the door may be aligned with the outer surface of the automobile. It is appreciated that the adjustment means 70 provided above may be provided in either or both of the bodies 53, 55.

In the above embodiments, the adjustment means 70 comprises a set screw 72. It is understood and appreciated that other elements providing similar function can be used to control the range of motion of the hinge 50, that is, adjustable in range of rotation according to the spatial direction .alpha.. Any element suitable for engagement of the shoe 66 that is slidingly engaged with the sliding guide 64 is appreciated so as to limit the maximum extent of translation of the shoe 66 within the sliding guide 64 controlling the angle .alpha. in which the hinge 50 opens and/or closes. Suitable elements include, but not limited to, pins, posts, and detent means, whether user adjustable or not.

Referring again to FIG. 5, the hinge 50 further comprises reinforcement inserts 76 in accordance with an embodiment of the present invention. The reinforcement inserts 76 are coupled to and provide additional support material to reinforce either the roof header 22 and/or the door upper edge 32. The reinforcement inserts 76 are particularly advantageous wherein the roof header 22 and/or the door upper edge 32 has insufficient strength and stiffness to support the loads on the hinges 50. In accordance with an embodiment of the present invention, the reinforcement inserts 76 comprise a recess portion 82 adapted to receive one of the bodies 53, 55 therein and an exterior surface 86 suitable for coupling to the respective roof header 22 or door upper edge 32. The recess portion 82 further comprises suitable fastener receiving elements 84 coaxially aligned with corresponding fastener apertures 88 in the flange 60 of the fastening element 52 adapted to receive a suitable fastener (not shown) so as to couple the fastening element 52 to the reinforcement insert 76.

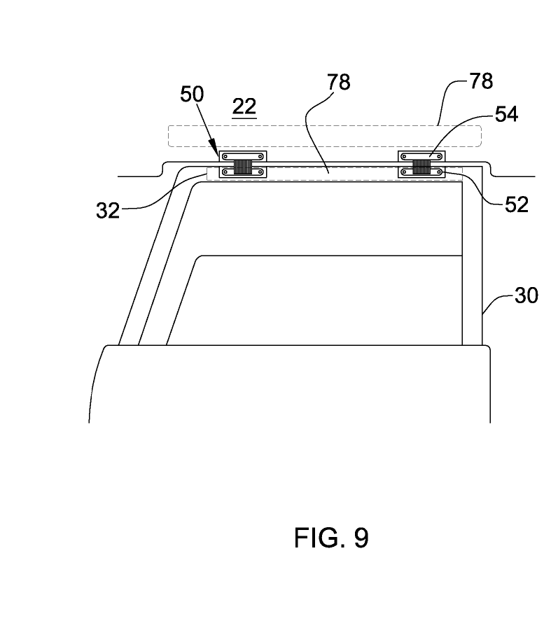

FIG. 9 is a front view of the hinge 50 as shown in a typical installation, in accordance with the present invention. The first fastening element 52 is coupled to the door upper edge 32 and the second fastening element 54 is coupled to the roof header 22. The door upper edge 32 and/or the roof header 22 is provided with a box beam 78 to provide structural support to the door upper edge 32 and/or the roof header 22 as needed to support the loading on the hinges 50. Referring also to FIG. 5, the reinforcement inserts 76 may be coupled to the box beam 78 or recessed into the box beam 78 suitable for a particular purpose.

Thus, it is seen that the embodiments provided above provide a gull-wing-type door operation by which the door extends above the vehicle body.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiment shown and described without departing from the scope of the present invention. Those with skill in the art will readily appreciate that the present invention may be implemented in a very wide variety of embodiments. This application is intended to cover any adaptations or variations of the embodiments discussed herein. Therefore, it is manifestly intended that this invention be limited only by the claims and the equivalents thereof.

What is claimed:

1. A hinge, in particular for vehicle doors adapted to provide gull-wing operation, comprising:
a first and second fastening element each provided with a fixed pivot pin and a sliding guide;
linkages each having a first and second extremity for coupling the first and second fastening elements respectively with the first extremity hinged on the fixed pivot pin of one of the fastening elements and with the second extremity engaged in the sliding guide of the other fastening element, the second extremity including a shoe adapted for sliding engagement within the sliding guide;
a joint interposed between the extremities of the linkages which pivotally couples the linkages to each other allowing their relative angular mobility; and
an adjustable control means operatively engaged with the sliding guide and shoe so as to control the maximum range of rotation of the hinge.

2. The hinge of claim 1, wherein the control means comprises a set screw engaged in a threaded bore aligned and in cooperative engagement with the sliding guide and shoe so as to provide adjustability of the limit of the opening range of the hinge by the extend of advancement of the set screw within the threaded bore with abutment of the set screw with the shoe.

3. The hinge of claim 2, wherein the linkages are dimensioned and shaped to allow the rotation of a door relative to a roof header between two extreme positions, in one of which the door is closed and aligned with an exterior face thereof to a surface of an automobile and in a second position the door being open and positioned above the roof header.

4. The hinge of claim 2, wherein the hinge further comprises reinforcement inserts each comprising a recess portion adapted to receive one of the fastening elements therein, the recess portion further comprising fastener receiving elements coaxially aligned with corresponding fastener apertures in the fastening element adapted to receive a suitable fastener so as to couple the fastening element to the reinforcement insert.

5. A hinge, in particular for automobile doors adapted to provide gull-wing operation, comprising:
at least two fastening elements each provided with a fixed pivot pin and with a sliding guide;
a first and second linkage each having a first and second extremity coupled to the fastening elements respectively with their first extremity hinged on the fixed pivot pin of one of the fastening elements and with a second extremity engaged in the sliding guide of the other fastening element, the second extremity including a shoe adapted for sliding engagement within the sliding guide;
a joint interposed between the extremities of the linkages which pivotally connects the linkages to each other allowing their relative angular mobility; and
an adjustable control means operatively engaged with the sliding guide and shoe so as to control the maximum range of rotation of the hinge.

6. A hinge, in particular for an automobile adapted to provide gull-wing operation, the automobile having a roof header and a door, comprising:
a first fastening element and a second fastening element each adapted to be coupled to either of the door and the roof header;
a first linkage and second linkage advantageously articulated to each other and to the fastening elements, the fastening elements are embodied by corresponding internally hollow bodies and provided with planar flanges, each of the bodies is internally provided with a fixed pivot pin and with a sliding guide, the pivot pin oriented parallel to a first direction, the sliding guides are rectilinear and oriented orthogonal to the first direction;
each linkage comprises a first extremity hinged on the fixed pivot pin of one of the first and second fastening elements, and a second extremity, which is provided with a shoe, engaged in the sliding guide of the other of the first and second fastening element, the two linkages are mutually coupled in pivoting fashion by a joint disposed between the respective extremities, the linkages generally having an elongated, globally curvilinear shape, substantially similar in design and dimensions, operatively related to rotate between an open and closed position, wherein the linkages comprise a first linkage portion disposed between the first extremity and the joint and as a second linkage portion disposed between the joint and the second extremity, wherein the two linkages have mutually the same lengths, both in correspondence with their first linkage portions, and in correspondence with their second linkage portions; and
an adjustment means in operable engagement with the shoe so as to limit the range of rotation of the hinge.

7. The hinge of claim 6 wherein the adjustment means comprises a set screw adapted for operable engagement with a threaded bore extending from a hinge front and in operable alignment with the sliding guide, the set screw extending into the sliding guide so as to engage the shoe so as to limit the maximum extent of translation of the shoe within the sliding guide controlling the angle in which the hinge opens, wherein rotation of the set screw in a first direction extends the set screw further into operable engagement with the sliding guide restricting the range of motion of the shoe and thus the range of rotation of the hinge, and wherein rotation of the set screw in a second direction opposite the first direction backs out the set screw from the sliding guide allowing for a greater range of motion of the shoe and thus the range of rotation of the hinge.

8. The hinge of claim 6 wherein the adjustment means comprising a set screw adapted for operable engagement with a threaded bore extending from a hinge rear and in operable alignment with the sliding guide, the set screw adapted to engage the shoe slidingly engaged with the sliding guide so as to limit the extent of translation of the shoe within the sliding guide controlling the angle in which the hinge closes, wherein rotation of the set screw in a first direction extends the set screw further into operable engagement with the sliding guide restricting the range of motion of the shoe and thus the range of rotation of the hinge, and wherein rotation of the set screw in a second direction opposite the first direction backs out the set screw from the sliding guide allowing for a greater range of motion of the shoe and thus the range of rotation of the hinge.

9. The hinge of claim 6 further comprising reinforcement inserts each comprising a recess portion adapted to receive one of the fastening elements therein, the recess portion further comprising fastener receiving elements coaxially aligned with corresponding fastener apertures of the fastening element adapted to receive a suitable fastener so as to couple the fastening element to the reinforcement insert.
